(19) United States
(12) Patent Application Publication
(10) Pub. No.: US 2026/0061572 A1
(43) Pub. Date: Mar. 5, 2026

(54) RECESSED SPRING FOR A RATCHET TOOL

(71) Applicant: Harbor Freight Tools USA, Inc., Calabasas, CA (US)

(72) Inventor: Oaty A. Frye, Middleton, CT (US)

(21) Appl. No.: 18/819,010

(22) Filed: Aug. 29, 2024

(51) Int. Cl. B25B 13/46

(52) U.S. Cl. CPC B25B 13/463

(57) ABSTRACT

A ratchet tool including a ratchet head attached to a handle is disclosed. The ratchet tool includes a ratchet assembly cavity operable to receive a ratchet gear including ratchet teeth, a pawl including pawl teeth, and a selector switch. The ratchet tool further includes an alignment spring positioned within a spring recess. The alignment spring is compressed when a cover plate is fastened to the ratchet head. The compression of the alignment spring contributes to preventing undesired rotation of the ratchet gear within the ratchet assembly cavity to ensure parallelism of the ratchet teeth and the pawl teeth.

### BACKGROUND

The present disclosure relates generally to ratchet tools. An exemplary ratchet tool include for example, a ratchet wrench, torque wrench, or a combination wrench. Such tools have a selectable ratcheting functionality for applying torque in both a clockwise and counterclockwise direction. Specifically, the engagement between the teeth of a ratchet gear and the teeth of a movable pawl selectively limit the rotation in either a clockwise or counterclockwise direction to transmit torque via a drive member attached to the ratchet gear. Ratchet tools may be used in an automotive, shop, or construction environment when assembling or removing objects (e.g., tightening or untightening bolts or nuts).

### SUMMARY

A ratchet tool is disclosed, substantially as illustrated by and described in connection with at least one of the figures, as set forth more completely in the claims.

Specifically disclosed is an embodiment of a ratchet tool that comprises a head operably connected to a handle, the head including a ratchet assembly cavity. The ratchet assembly cavity may include a bottom wall. The Ratchet tool further comprises a cover plate adapted to enclose the ratchet assembly cavity and a ratchet gear disposed in the ratchet assembly cavity. The ratchet gear includes a top surface, a bottom surface, circumferential gear teeth disposed between the top surface and the bottom surface, a drive extending from the top surface, the drive being operable to transmit torque to a work piece, and a spring recess. The ratchet tool further comprises a pawl disposed in the ratchet assembly cavity adjacent the ratchet gear, a selector switch, and a spring disposed within the spring recess of the ratchet gear. The spring recess is operable to at least partially retain the spring. The spring is operable to maintain a parallel alignment between the circumferential gear teeth and the pawl teeth.

In another embodiment, the top surface of the ratchet gear contacts the cover plate and the bottom surface of the ratchet gear contacts the bottom wall of the ratchet assembly cavity. In a further embodiment, the spring recess is disposed on the top surface of the ratchet gear. In some embodiments, the spring biases the ratchet gear towards the bottom wall of the ratchet assembly cavity. In other embodiments the spring recess is disposed on the bottom surface of the ratchet gear. In another embodiment the spring biases the ratchet gear towards the cover plate. In a further embodiment, the spring recess has an annular shape. In another embodiment, the spring recess is concentric with a circumference of the ratchet gear. In other embodiments, the spring is a flat spring.

Also disclosed is another embodiment of the ratchet tool comprising a head operably connected to a handle, the head including a ratchet assembly cavity, and wherein the ratchet assembly cavity includes a bottom wall. The ratchet tool further comprises a cover plate adapted to enclose the ratchet assembly cavity, wherein the cover plate includes a spring recess. The ratchet tool also comprises a ratchet gear disposed in the ratchet assembly cavity, which includes a top surface, a bottom surface, circumferential gear teeth disposed between the top surface and the bottom surface, and a drive extending from the top surface, the drive being operable to transmit torque to a work piece. The ratchet tool further comprises a pawl, a selector switch, and a spring disposed within the spring recess of the cover plate. The spring recess is operable to at least partially retain the spring. The spring is operable to maintain a parallel alignment between the circumferential gear teeth and the pawl teeth.

In another embodiment, the top surface of the ratchet gear contacts the cover plate and the bottom surface of the ratchet gear contacts the bottom wall of the ratchet assembly cavity. In a further embodiment, the spring biases the ratchet gear towards the bottom wall of the ratchet assembly cavity. In some embodiments, the spring recess has an annular shape. In other embodiments, the spring recess is concentric with a circumference of the ratchet gear. In additional embodiments, the spring is a flat spring.

Also disclosed is an embodiment of a ratchet tool comprising a head operably connected to a handle, the head including a ratchet assembly cavity, wherein the ratchet assembly cavity includes a bottom wall and the bottom wall includes a spring recess. The ratchet tool further comprises a cover plate adapted to enclose the ratchet assembly cavity. The ratchet tool also comprises a ratchet gear disposed in the ratchet assembly cavity, which includes, a top surface, a bottom surface, circumferential gear teeth disposed between the top surface and the bottom surface, and a drive extending from the top surface, the drive being operable to transmit torque to a work piece. The ratchet tool further comprises a pawl, a selector switch, and a spring disposed within the spring recess of the bottom wall of the ratchet assembly cavity. The spring recess is operable to at least partially retain the spring. The spring is operable to maintain a parallel alignment between the circumferential gear teeth and the pawl teeth.

In another embodiment, the top surface of the ratchet gear contacts the cover plate and the bottom surface of the ratchet gear contacts the bottom wall of the ratchet assembly cavity. In a further embodiment, the spring biases the ratchet gear towards the cover plate. In some embodiments, the spring recess has an annular shape concentric with a circumference of the ratchet gear. In other embodiments, the spring is a flat spring.

### BRIEF DESCRIPTION OF SEVERAL VIEWS OF DRAWINGS

The following is a brief description of the drawings pertaining to the present disclosure, which will be discussed in more detail in the detailed description section below:

FIG. 1 illustrates an exploded perspective view of a ratchet head of a ratchet tool.

FIG. 2 illustrates a top perspective, assembled view of the ratchet head showing a spring disposed within a spring recess, the cover plate is illustrated in ghost line to show the ratchet assembly within the ratchet head.

FIG. 3 illustrates a cross-sectional view of the ratchet head taken along the lines of A-A in FIG. 2, showing the spring recess disposed on a top surface of the ratchet gear, and showing reference to FIG. 4.

FIG. 4 illustrates a close-up cross sectional view of the spring disposed within the spring recess outlined in FIG. 3.

FIG. 5 illustrates a cross-sectional view of an alternative embodiment of the ratchet head taken along the lines of A-A in FIG. 2, showing the spring recess disposed within the cover plate, and showing reference to FIG. 6.

FIG. 6 illustrates a close-up cross sectional view of the spring disposed within the spring recess outlined in FIG. 5.

FIG. 7 illustrates a cross-sectional view of an alternative embodiment of the ratchet head taken along the lines of A-A in FIG. 2, showing the spring recess disposed on a bottom surface of the ratchet gear, and showing reference to FIG. 8.

FIG. 8 illustrates a close-up cross sectional view of the spring disposed within the spring recess outlined in FIG. 7.

FIG. 9 illustrates a cross-sectional view of an alternative embodiment of the ratchet head taken along the lines of A-A in FIG. 2, showing the spring recess disposed on a bottom wall of the ratchet assembly cavity, and showing reference to FIG. 10.

FIG. 10 illustrates a close-up cross sectional view of the spring disposed within the spring recess outlined in FIG. 9.

The foregoing summary, as well as the following detailed description of certain features of the present application, are better understood when read in conjunction with the appended drawings. For the purposes of illustration, certain features are shown in the drawings. It should be understood, however, that the claims are not limited to the arrangements shown in the attached drawings. Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of applications comprising one or more embodiments of the disclosure. As such, the drawings are not meant to include all conventional features known by those of ordinary skill in the art to be required for the practice of the embodiments disclosed herein.

### DETAILED DESCRIPTION

The present disclosure relates to a ratchet tool that enables a user to selectively determine the direction (i.e., clockwise or counter-clockwise) in which torque is applied to a work piece (not shown). Amongst other factors, a reliable ratchet tool requires stabile yet dynamic engagement of the tool's internal and/or external components. Ratchet tools generally include a ratchet assembly cavity in a ratchet head that receives a cylindrical ratchet gear attached to the drive member, a pawl to engage the ratchet gear, a switch to control the relative orientation of the pawl with respect to the gear, and a biasing member disposed within the switch. A cover plate may be attached to the ratchet head to retain the internal components within the cavity of the ratchet tool. The ratchet gear includes circumferential gear teeth that engage teeth on the pawl.

The parallel positioning of the ratchet gear teeth relative to the pawl teeth is one of the most important properties of a ratchet wrench. Such parallelism of the gear teeth and the pawl teeth contributes to the durability, torque limit, and slippage risk of a ratchet design. Some ratchet tools include an alignment spring that biases the ratchet gear within the ratchet assembly cavity to assist in aligning the ratchet gear teeth with the pawl teeth. In such ratchet tool designs, the spring rests on a top surface of the ratchet gear and an opposing inside surface of either a cover plate or bottom surface of the ratchet assembly cavity. The spring biases the ratchet gear against either the cover plate or the bottom wall of the ratchet assembly cavity to assist in aligning the ratchet gear with the pawl. These ratchet designs typically include a void between the ratchet gear-surface the spring rests on and its opposing surface of either the cover plate or bottom wall of the ratchet assembly cavity. Because springs are compressive by nature, the springs in such ratchet designs may flex and shift in position within the void when any amount of a side load was applied to the ratchet drive member during use. A shift in position of the spring within the void may contribute to misalignment of the ratchet gear (i.e., a loss of parallelism of the ratchet gear teeth with the pawl teeth). Such lack of parallelism could result in damaged teeth and/or reduced torque.

It is therefore advantageous to improve the reliability of a ratchet tool by stabilizing the ratchet gear, limiting any undesired movement of the alignment spring, and reducing the size of any void between the ratchet gear and opposing surfaces. The present disclosure thus relates generally to a spring disposed in a spring recess. The spring recess is specifically sized to accommodate the spring, therefore, substantially eliminating the larger void and optimizing the clearance between the ratchet gear, cover plate, and bottom wall of the ratchet assembly cavity. In such a design, the movement of the ratchet gear along the y-axis and rotation about the z-axis is substantially restricted due to the ridged boundary of the cover plate and bottom surface of the ratchet assembly cavity (as opposed to relying on the elasticity of the spring itself). Likewise, any undesired movement of the alignment spring is substantially eliminated because the spring is nested within the spring recess. Consequently, even when large side loads are applied to the ratchet drive, the gear does not, and cannot, move along the y-axis and/or rotate about the z-axis beyond its intended limits. Thus eliminating any loss of parallelism between the ratchet gear teeth and the pawl teeth, increasing the durability and dependability of the ratchet assembly mechanism.

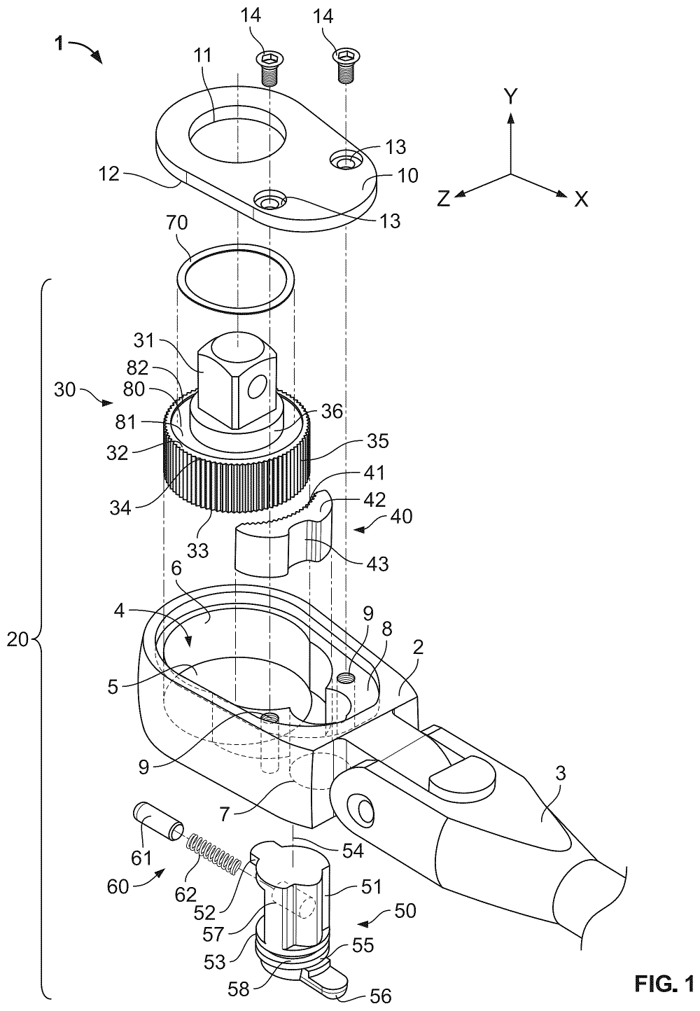

A ratchet tool 1 is shown in the exploded view of FIG. 1. Also shown in FIG. 1 are x, y, and z axes to assist in the description of the various movements and relationships of the internal components of the ratchet tool 1. As illustrated, the ratchet tool 1 includes a ratchet head 2 and a handle 3. The handle 3 may be gripped by a user to operate the ratchet tool 1. The ratchet tool 1 of the present disclosure comprises a ratchet assembly 20 that includes a ratchet gear 30, a pawl 40, a selector switch 50, and a biasing member 60. The ratchet assembly 20 is disposed in a ratchet assembly cavity 4 of the ratchet head 2. The ratchet assembly cavity 4 includes a bottom wall 5, a sidewall 6, and a switch aperture 7 operable to receive at least a portion of the selector switch 50 to extend out of the ratchet assembly cavity 4. The sidewall 6 may be a generally arcuate shape that is substantially complementary to the shape of the ratchet gear 30, pawl 40, and selector switch 50. When assembled, ratchet gear 30 and pawl 40 contact the bottom wall 5 of the ratchet assembly cavity 4. A cover plate 10 couples to the ratchet head 2, substantially sealing the ratchet assembly cavity 4 and retaining the ratchet assembly 20 within the ratchet head 2.

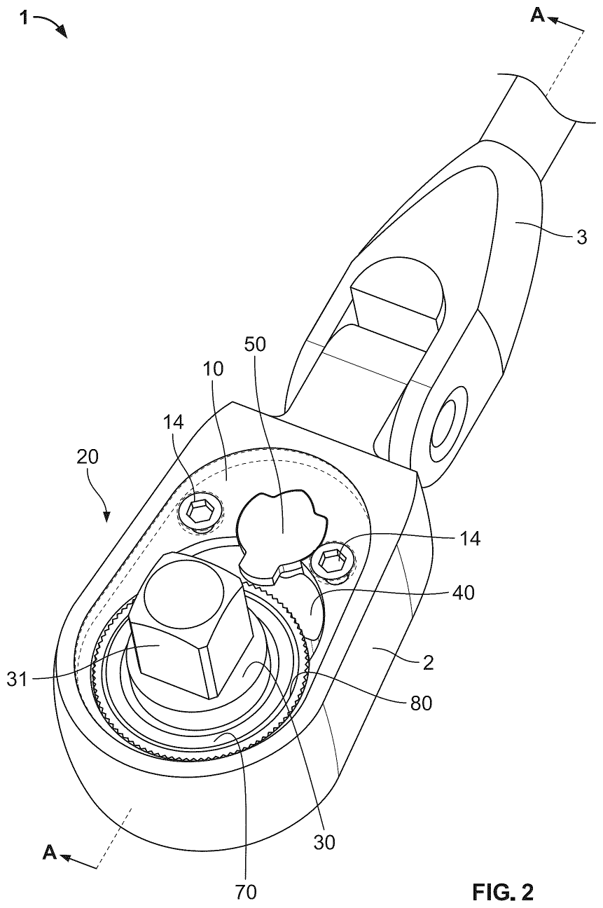

FIGS. 1 and 2 show the selector switch 50 rotatably disposed through the switch aperture 7 and positioned within the ratchet assembly cavity 4. The selector switch 50 includes a switch body 51 and a first ledge 52 that extends away, or laterally, from a central z-axis 54 of the switch body 51. The selector switch 50 further includes a second ledge 53 that extends away, or laterally, from the central z-axis 54 of the switch body 51. A portion of the pawl 40 is received between the first ledge 52 and the second ledge 53, thereby limiting movement of the pawl 40 along the y-axis when the selector switch 50 is rotated clockwise or counter-clockwise. As shown, the first ledge 52 is positioned on one side of the biasing member 60 and the second ledge 53 is positioned on the opposite side of the biasing member 60. The selector switch 50 may include an o-ring 58 disposed around a neck 55 of the selector switch 50 to seal the switch aperture 7, thereby preventing debris and/or fluids from entering the ratchet assembly cavity 4 through the switch aperture 7.

A user may activate the selector switch 50 via a switch lever 56 extending out of the switch aperture 7. The user may rotate the selector switch 50, via the lever 56, either clockwise or counter-clockwise along the y-axis to move the pawl 40 to engage with the ratchet gear 30. Further, as shown in the illustrated embodiment, the selector switch 50 defines a bore 57 configured to partially receive the biasing member 60 that includes a pin 61 and a biasing spring 62. The biasing member 60 uses elastic potential energy, i.e., a biasing force generated by the compression of the biasing spring 62, to bias (i.e., push) the pin 61 into engagement with the pawl 40, thereby pushing the pawl 40 against the ratchet gear 30.

FIGS. 1-2 show the ratchet gear 30 rotatably disposed in the ratchet assembly cavity 4. The ratchet gear 30 includes a drive member 31, protruding from, and centrally located on a top surface 32 of the ratchet gear 30. The ratchet gear 30 may also include a round collar 36 positioned between top surface 32 and the drive member 31. The collar 36 may substantially correspond to the shape to a drive aperture 11 of the cover plate 10 to prevent debris and/or fluids from entering the ratchet assembly cavity 4 through the drive aperture 11. The drive member 31 is operable to transmit torque to a work piece (not shown). For example, the drive member 31 is operable to engage with a socket, fastener, or other tool. As shown, the drive member 31 has a substantially square shape, but may also have a rectangular or other shape. The drive member 31 may optionally include a ball detent operable to engage with a conventional socket. The ratchet gear 30 further defines a perimeter 34 (i.e., circumference) and a plurality of circumferential gear teeth 35 disposed about the perimeter 34 to selectively engage with the pawl 40.

The pawl 40 includes a body 42 that has a rounded shape that conforms to a portion of the perimeter of the ratchet gear 30. A plurality of pawl teeth 41 are disposed on the side of the pawl that faces the ratchet gear 30. The pawl 40 also includes a recessed portion 43 disposed within the pawl body 42 on the opposite side of the pawl teeth 41. The recessed portion 43 is operable to receive the biasing member 60 to selectively engage the pawl 40 into either the clockwise or counter-clockwise position. As shown in FIG. 2, the pawl teeth 41 are operable to selectively engage the circumferential ratchet gear teeth 35 to limit rotation of the ratchet gear 30 in either the clockwise or the counterclockwise direction (about the y-axis). Specifically, in operation, the pawl 40 is wedged between the side wall 6 of the ratchet assembly cavity 4 and the ratchet gear 30 (on either the left (counter-clockwise) or right side (clockwise) of the ratchet gear 30 depending on the selected drive direction) when the selector switch 50 is positioned in either the clockwise or counter-clockwise position. The position of the pawl 40 relative to the ratchet gear 30, and specifically the engagement of the pawl teeth 41 with the gear teeth 35, limits rotation of the ratchet gear 30 in either the clockwise or counter-clockwise direction, such that torque can be applied to a work piece (not shown) in a clockwise or counter-clockwise direction.

FIGS. 1-2 show the cover plate 10 partially disposed in a cover plate cavity 8. The cover plate 10 is secured to the ratchet head 2 and is operable to retain the ratchet assembly 20 within the ratchet assembly cavity 4. As illustrated, the cover plate 10 includes the drive aperture 11 operable to receive at least a portion of the drive member 31 and a plurality of bores 13 operable to receive a plurality of screws 14. Similarly, the cover plate cavity 8 on the ratchet head 2 includes a plurality of threaded bores 9 co-axial with the plurality of bores 13 of the cover plate 10. The screws 14 are inserted through the plurality of bores 13 in the cover plate 10 and engaged with the threaded bores 9 to fasten the cover plate 10 to the ratchet head 2. Fastening the cover plate 10 to the ratchet head 2, compresses the cover plate 10 against the cover plate cavity 8 and against the internal components of the ratchet head 2 (i.e., the ratchet assembly 20) along the y-axis. The present disclosure contemplates that the cover plate 10 may be attached and/or fastened to the ratchet head 2 by other means, including for example, but not limited to a retaining clip.

FIGS. 1-2 also show an alignment spring 70 disposed between the ratchet gear 30 and the cover plate 10, substantially within a spring recess 80. As illustrated, the alignment spring 70 is a flat spring, but the present disclosure also contemplates other springs. The spring recess 80 is generally annular in shape and concentric with the circumference of the ratchet gear 30 and the drive member 31. The spring recess 80 includes a seat 81 and sidewalls 82. Further, as illustrated the spring recess 80 is sized to accommodate the alignment spring 70, such that movement of the alignment spring 70, within the spring recess 80, is restricted by the seat 81, sidewalls 82, and the round collar 36 of the ratchet gear 30. When the cover plate 10 is fastened to the ratchet head 2, the alignment spring 70 is compressed within the spring recess 80 (specifically between the bottom surface 12 of the cover plate 10 and the seat 81 of the spring recess 80). The alignment spring 70 thus uses elastic potential energy, i.e., a biasing force generated by the compression of the alignment spring 70, to bias (i.e., push) the ratchet gear 30 against either the bottom wall 5 of the ratchet assembly cavity 6 or the bottom surface 12 of the cover plate 10. This biasing assists in preventing undesirable lateral movement or rotation of the ratchet gear 30 with the ratchet assembly cavity 4, while the ratchet tool 1 is under load.

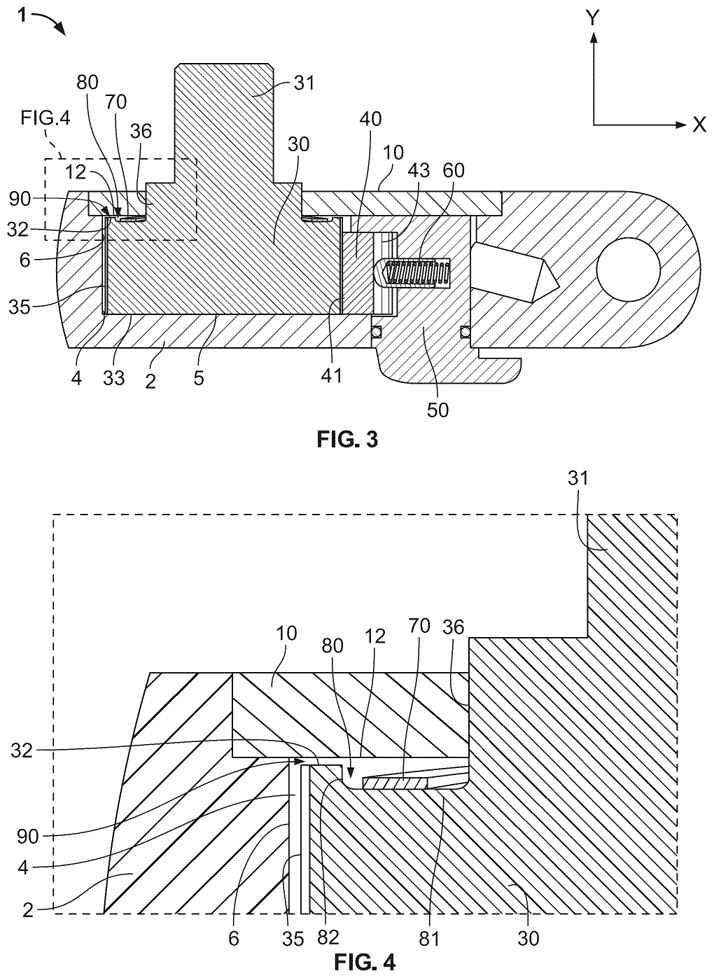

FIGS. 3 and 4 show a cross sectional view of the ratchet head 2 taken along line A-A in FIG. 2. As illustrated, the spring recess 80 is disposed within the top surface 32 of the ratchet gear 30. The alignment spring 70 is nested within the spring recess 80 (around the round collar 36 of the ratchet gear 30), such that movement of the alignment spring 70 within the spring recess 80 is substantially limited by the bottom surface 12 of the cover plate 10, and the seat 81 and sidewalls 82 of the spring recess 80. When the cover plate 10 is fastened to the ratchet head 2, the alignment spring 70 is compressed. In its compressed state, the alignment spring 70 exerts its stored spring energy and pushes against the cover plate 10 and the seat 81 of the spring recess 80, biasing the ratchet gear 30 against the bottom wall 5 of the ratchet assembly cavity 4. Such biasing helps prevent undesired rotation of the ratchet gear about the x-axis or the y-axis. The biasing of the ratchet gear 30 by the spring 70 also helps to prevent unwanted lateral shifting of the ratchet gear 30 along the y-axis across a gap 90 between the cover plate 10 and ratchet gear 30. The gap 90 ensures that the ratchet gear 30 can rotate freely about the y-axis within the ratchet assembly cavity 4 without binding up or jamming. The stored spring energy (i.e., biasing) of the spring 70 ensures that the ratchet gear 30 maintains a relative position along the y-axis, by spanning itself across the space within the gap 90 and biasing the ratchet gear 30 towards bottom wall 5 of the ratchet assembly cavity 4. Lateral shifting of the ratchet gear 30 along the x-axis or z-axis is substantially prevented by the sidewall 6 of the ratchet assembly cavity 4 and the pawl 40. Consequently, the position of the ratchet gear 30 within the ratchet head 2 is substantially isolated (fixed), such that only rotation about the y-axis (drive axis) is possible.

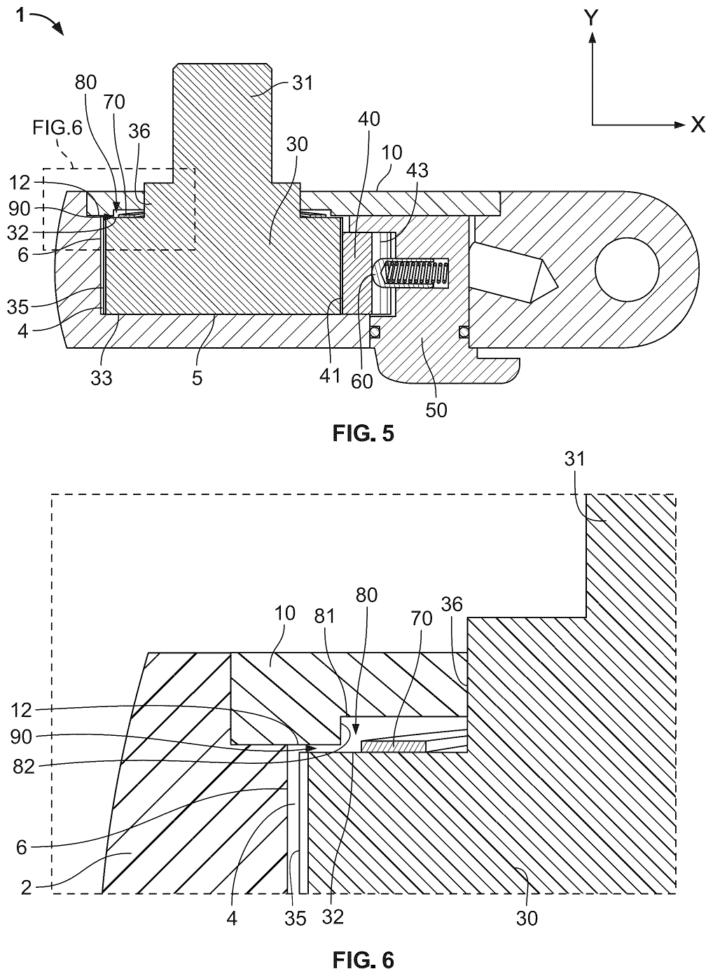

FIGS. 5 and 6 show a cross-sectional view of an alternative embodiment of the ratchet head 2 taken along line A-A in FIG. 2. As illustrated, the spring recess 80 is disposed within the bottom surface 12 of the cover plate 10. The alignment spring 70 is nested within the spring recess 80 (around the round collar 36 of the ratchet gear 30), such that movement of the alignment spring 70 within the spring recess 80 is substantially limited by the top surface 32 of the ratchet gear 30, the round collar 36 of the ratchet gear 30, and the seat 81 and sidewall 82 of the spring recess 80. When the cover plate 10 is fastened to the ratchet head 2, the alignment spring 70 is compressed. In its compressed state, the alignment spring 70 exerts its stored spring energy and pushes against the seat 81 of the spring recess 80 and top surface 32 of the ratchet gear 30, biasing the ratchet gear 30 against the bottom wall 5 of the ratchet assembly cavity 4. Such biasing helps prevent undesired rotation of the ratchet gear about the x-axis or the y-axis. The biasing also prevents lateral shifting of the ratchet gear 30 along the y-axis across a gap 90 between the cover plate 10 and ratchet gear 30. The gap 90 ensures that the ratchet gear 30 can rotate freely about the y-axis within the ratchet assembly cavity 4 without binding up or jamming. The spring 70 and stored spring energy thereof, ensures that the ratchet gear 30 maintains a relative position along the y-axis, by spanning itself across the space within the gap 90 and biasing the ratchet gear 30 towards the bottom surface 33 of the ratchet gear 30. Lateral shifting of the ratchet gear 30 along the x-axis or z-axis is substantially prevented by the sidewall 6 of the ratchet assembly cavity 4 and the pawl 40. Consequently, the position of the ratchet gear 30 within the ratchet head 2 is substantially isolated (fixed), such that only rotation about the y-axis (drive axis) is possible.

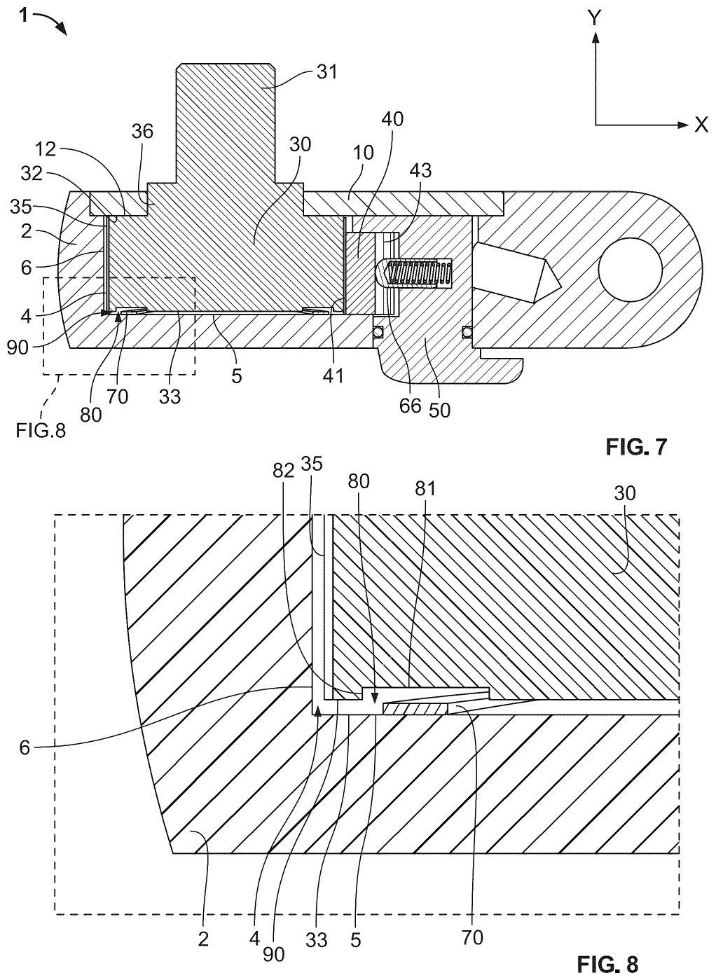

FIGS. 7 and 8 show a cross-sectional view of another alternative embodiment the ratchet head 2 taken along line A-A in FIG. 2. As illustrated, the spring recess 80 is disposed within the bottom surface 33 of the ratchet gear 30. The alignment spring 70 is nested within the spring recess 80, such that movement of the alignment spring 70 within the spring recess 80 is substantially limited by the bottom wall 5 of the ratchet assembly cavity 4, and the seat 81 and the sidewalls 82 of the spring recess 80. When the cover plate 10 is fastened to the ratchet head 2, the alignment spring 70 is compressed. In its compressed state, the alignment spring 70 exerts its stored spring energy and pushes against the bottom wall 5 of the ratchet assembly cavity 4 and the seat 81 of the spring recess 80, biasing the ratchet gear 30 against the bottom surface 12 of the cover plate 10. Such biasing helps prevent undesired rotation of the ratchet gear about the x-axis or the y-axis. The biasing of the ratchet gear 30 by the spring 70 also helps to prevent unwanted lateral shifting of the ratchet gear 30 along the y-axis across a gap 90 between surface 32 of the ratchet gear 30 and the bottom wall 5 of the ratchet assembly cavity 4. The gap 90 ensures that the ratchet gear 30 can rotate freely about the y-axis within the ratchet assembly cavity 4 without binding up or jamming. The stored spring energy (i.e., biasing) of the spring 70 ensures that the ratchet gear 30 maintains a relative position along the y-axis, by spanning itself across the space within the gap 90 and biasing the ratchet gear 30 towards the bottom surface 12 of the cover plate 10. Lateral shifting of the ratchet gear 30 along the x-axis or z-axis is substantially prevented by the sidewall 6 of the ratchet assembly cavity 4 and the pawl 40. Consequently, the position of the ratchet gear 30 within the ratchet head 2 is substantially isolated (fixed), such that only rotation about the y-axis (drive axis) is possible.

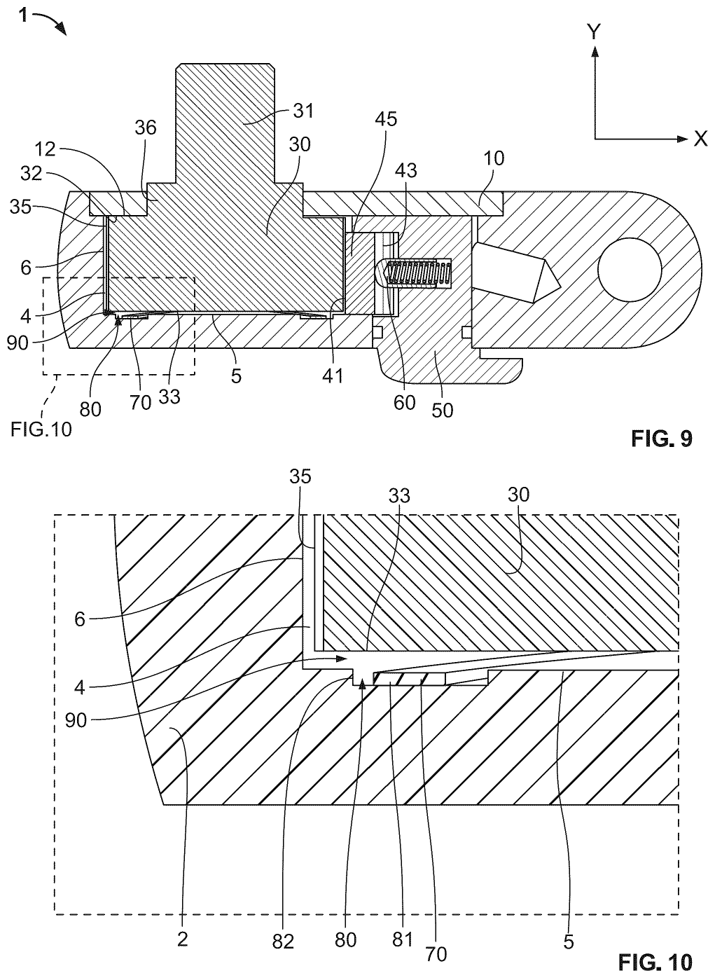

FIGS. 9 and 10 show a cross-sectional view of another alternative embodiment the ratchet head 2 taken along line A-A in FIG. 2. As illustrated, the spring recess 80 is disposed within the bottom wall 5 of the ratchet assembly cavity 4. The alignment spring 70 is nested within the spring recess 80, such that movement of the alignment spring 70 within the spring recess 80 is substantially limited by the bottom surface 33 of the ratchet gear 30, and the seat 81 and the sidewalls 82 of the spring recess 80. When the cover plate 10 is fastened to the ratchet head 2, the alignment spring 70 is compressed. In its compressed state, the alignment spring 70 exerts its stored spring energy and pushes against the bottom surface 33 of the ratchet gear 30 and the seat 81 of the spring recess 80, biasing the ratchet gear 30 against the bottom surface 12 of the cover plate 10. Such biasing helps prevent undesired rotation of the ratchet gear 30 about the x-axis or the y-axis. The biasing of the ratchet gear 40 by the spring 70 also helps to prevent unwanted lateral shifting of the ratchet gear 30 along the y-axis across a gap 90 between surface 32 of the ratchet gear 30 and the bottom wall 5 of the ratchet assembly cavity 4. The gap 90 ensures that the ratchet gear 30 can rotate freely about the y-axis within the ratchet assembly cavity 4 without binding up or jamming. The stored spring energy (i.e., biasing) of the spring 70 ensures that the ratchet gear 30 maintains a relative position along the y-axis, by spanning itself across the space within the gap 90 and biasing the ratchet gear 30 towards the bottom surface 12 of the cover plate 10. Lateral shifting of the ratchet gear 30 along the x-axis or z-axis is substantially prevented by the sidewall 6 of the ratchet assembly cavity 4 and the pawl 40. Consequently, the position of the ratchet gear 30 within the ratchet head 2 is substantially isolated (fixed), such that only rotation about the y-axis (drive axis) is possible.

The present disclosure is described in such full, clear, concise, and exact terms as to enable any person skilled in the art to which it pertains to practice the same. It is to be understood that the foregoing described preferred aspects of the disclosure and that modification may be made therein without departing from the spirit of scope of the disclosure as set forth in the appended claims. The scope of the following claims is to be accorded the broadest interpretation to encompass all such modifications and equivalent structures and functions. Therefore, it is intended that the application not be limited to the particular aspects disclosed, but that the application will include all aspects falling within the scope of the appended claims.

What is claimed:

1. A ratchet tool comprising:
a head operably connected to a handle, the head including a ratchet assembly cavity, wherein the ratchet assembly cavity includes a bottom wall;
a cover plate adapted to enclose the ratchet assembly cavity;
a ratchet gear disposed in the ratchet assembly cavity, the ratchet gear including:
a top surface,
a bottom surface,
circumferential gear teeth disposed between the top surface and the bottom surface,
a drive extending from the top surface, the drive being operable to transmit torque to a work piece, and
a spring recess;
a pawl disposed in the ratchet assembly cavity adjacent the ratchet gear a selector switch; and
a spring disposed within the spring recess of the ratchet gear,
wherein:
the spring recess is operable to at least partially retain the spring, and
the spring is operable to maintain a parallel alignment between the circumferential gear teeth and the pawl teeth.

2. The ratchet tool of claim 1, wherein the top surface of the ratchet gear contacts the cover plate and the bottom surface of the ratchet gear contacts the bottom wall of the ratchet assembly cavity.

3. The ratchet tool of claim 2, wherein the spring recess is disposed on the top surface of the ratchet gear.

4. The ratchet tool of claim 3, wherein the spring biases the ratchet gear towards the bottom wall of the ratchet assembly cavity.

5. The ratchet tool of claim 2, wherein the spring recess is disposed on the bottom surface of the ratchet gear.

6. The ratchet tool of claim 5, wherein the spring biases the ratchet gear towards the cover plate.

7. The ratchet tool of claim 1, wherein the spring recess has an annular shape.

8. The ratchet tool of claim 7, wherein the spring recess is concentric with a circumference of the ratchet gear.

9. The ratchet tool of claim 1, wherein the spring is a flat spring.

10. A ratchet tool comprising:
a head operably connected to a handle, the head including a ratchet assembly cavity, wherein the ratchet assembly cavity includes a bottom wall;
a cover plate adapted to enclose the ratchet assembly cavity, wherein the cover plate includes a spring recess;
a ratchet gear disposed in the ratchet assembly cavity, the ratchet gear including:
a top surface,
a bottom surface,
circumferential gear teeth disposed between the top surface and the bottom surface, and
a drive extending from the top surface, the drive being operable to transmit torque to a work piece;
a pawl;
a selector switch; and
a spring disposed within the spring recess of the cover plate,
wherein:
the spring recess is operable to at least partially retain the spring, and
the spring is operable to maintain a parallel alignment between the circumferential gear teeth and the pawl teeth.

11. The ratchet tool of claim 10, wherein the top surface of the ratchet gear contacts the cover plate and the bottom surface of the ratchet gear contacts the bottom wall of the ratchet assembly cavity.

12. The ratchet tool of claim 11, wherein the spring biases the ratchet gear towards the bottom wall of the ratchet assembly cavity.

13. The ratchet tool of claim 10, wherein the spring recess has an annular shape.

14. The ratchet tool of claim 13, wherein the spring recess is concentric with a circumference of the ratchet gear.

15. The ratchet tool of claim 10, wherein the spring is a flat spring.

16. A ratchet tool comprising:
a head operably connected to a handle, the head including a ratchet assembly cavity, wherein the ratchet assembly cavity includes a bottom wall and the bottom wall includes a spring recess;
a cover plate adapted to enclose the ratchet assembly cavity;
a ratchet gear disposed in the ratchet assembly cavity, the ratchet gear including:
a top surface,
a bottom surface,
circumferential gear teeth disposed between the top surface and the bottom surface, and
a drive extending from the top surface, the drive being operable to transmit torque to a work piece;
a pawl;
a selector switch; and
a spring disposed within the spring recess of the bottom wall of the ratchet assembly cavity,
wherein:
the spring recess is operable to at least partially retain the spring, and
the spring is operable to maintain a parallel alignment between the circumferential gear teeth and the pawl teeth.

17. The ratchet tool of claim 16, wherein the top surface of the ratchet gear contacts the cover plate and the bottom surface of the ratchet gear contacts the bottom wall of the ratchet assembly cavity.

18. The ratchet tool of claim 17, wherein the spring biases the ratchet gear towards the cover plate.

19. The ratchet tool of claim 16, wherein the spring recess has an annular shape concentric with a circumference of the ratchet gear.

20. The ratchet tool of claim 16, wherein the spring is a flat spring.
